(19) United States
(12) Patent Application Publication
(10) Pub. No.: US 2005/0178649 A1
(43) Pub. Date: Aug. 18, 2005

(54) Reactor and method for treating fluids by using photocatalysts coupled with phosphorescent solids

(76) Inventor: Werner Liedy, Hochdorf-Assenheim (DE)

Correspondence Address: BORDEN LADNER GERVAIS LLP, 1100-100 QUEEN ST, OTTAWA, ON, K1P 1J9, CA

(21) Appl. No.: 10/510,980

(22) PCT Filed: Apr. 10, 2003
(86) PCT No.: PCT/EP03/03706

(30) Foreign Application Priority Data
Apr. 13, 2002 (DE) 102 16 477.0

(51) Int. Cl. B01J 19/08

(52) U.S. Cl. 204/157.15; 422/186

(57) ABSTRACT

The invention relates to a reactor for carrying out photocatalysed reactions in liquid or gaseous reaction media, consisting of a reactor vessel with a solid photocatalyst (PC), feed lines and take-off lines, mixing means, and a means of supplying electromagnetic radiation, containing microradiators which absorb the electromagnetic radiation and, with a time delay, emit light which excites the photocatalyst, and also to a process for carrying out photocatalytic reactions, in which solid PC are suspended in the liquid or gaseous reaction medium and are activated by means of microradiators which are charged up at an electromagnetic radiation source and which emit this energy with a time delay.

The invention relates to a new reactor and process design for the industrial application of photocatalysis.

### DESCRIPTION OF THE PRIOR ART

Photocatalysis is an effect that occurs when an electrical semiconductor is brought into contact with reactive substances. As a result of the irradiation, electrons are then promoted to a conduction band at a higher energy level. This leaves a “hole”. The excited electron and/or the hole can enter into redox reactions, for example, with molecules or free radicals on the surface of the semiconductor. In this way, in the presence of oxygen, the majority of organic molecules, bacteria and viruses are completely oxidized.

Applications already exist for the purification of water and gases (Bahnemann, Detlef: “Photocatalytic Detoxification of Polluted Waters”, in the Handbook of Environmental Chemistry, O. Hutzinger (Ed.) Vol. 2.: Reactions and Processes, Part L: Environmental Photochemistry, P. Boule (Ed.), Springer Verlag Heidelberg 1999, 285-351). The photocatalyst employed most frequently is TiO₂. With an energy band gap of 3.2 eV it can be activated with ultraviolet light having a wavelength of less than 385 nm. However, many other photocatalysts exist as well, some of them with a lower-lying band gap. These can be activated with light of higher wavelength. Work has been carried out recently into the development of photocatalysts having a wide variety of properties. As the excitational energy, mention may be made in this context in particular of the region of visible light (Lettmann, Christian: “Konventionelle und kombinatorische Entwicklung von Mischoxiden zur photokatalytischen Wasserreinigung mit sichtbarem Licht” [Conventional and combinatorial development of mixed oxides for the photocatalytic purification of water with visible light], dissertation at the University of the Saarland, 2001) and the use of sunlight (EP 0 812 619 A1).

The literature describes a variety of reactor designs.

One widespread reactor is the “multilayer cellular plate reactor”, in which the fluid to be treated flows meanderingly over a surface which is coated with photocatalyst (EP 0 738 686 A1). The catalyst is irradiated through the fluid, with excitation by sunlight and TiO₂ as catalyst in the described case of a wastewater purification. A variant is described in which the catalyst is suspended in the fluid and separated off again after passage through the apparatus. The space occupied by such apparatus is extremely large.

Cartridges are described which contain the catalyst and are traversed by a flow of the fluid under treatment. Illumination takes place with lamps mounted laterally on the cartridges (WO 96/36565). This apparatus occupies a similar amount of space to the “multilayer cellular plate reactor”.

The “packed sphere reactor” consists of glass beads which are coated with catalyst and have interstices through which the fluid flows (WO 95/11751).

Irradiation takes place by means of lamps which are introduced into the bed. The reactor is employed most frequently in fixed-bed form, but also as a fluidized bed. A disadvantage is that the packing density can only be increased at the expense of a reduced depth of penetration of the radiation.

In suspension reactors a catalyst in finely divided suspension is irradiated with differently arranged lamps (EP 0 233 498 B1). As a result of the substantial shading caused by other particles of catalyst or reagent, only a very small fraction of the catalyst surface present is activated in each case, unless highly dilute catalyst solutions are employed, in which case the conversion is lower.

Arrangements are described in which the light is transported to the photocatalyst through glass plates (WO 97/37936). Space occupancy and complex construction correspond to those of the above-described cellular plate reactors.

WO 98/17390 describes an arrangement having a multiplicity of small, thin glass plates. These plates carry the catalyst on their surface. Irradiation is accomplished by means of lamps which penetrate the annular stack of glass plates by means of cutouts in the glass plates. The design is very intricate and complex.

Disadvantages of the Prior Art and Requirements Resulting Therefrom

A common drawback of all the known reactor designs is that the packing density of the irradiated catalyst surface is very low. This makes the apparatus expensive. Moreover, they often take up a considerable amount of space, which likewise makes them more expensive to use. The somewhat more compact designs that are known are highly intricate and of complex construction, and accordingly are expensive.

These circumstances harbour the real reason why photocatalysis has not become established to date on the industrial scale.

The object which therefore arose was to develop a process and apparatus which combine a very high packing density of the Irradiated catalyst surface with a very cost-effective design and mode of operation.

This object is achieved by the features of the main claims and promoted by those of the dependent claims.

Transport of Energy by Phosphorescent Substances

The invention is based on the innovative principle of transporting the required energy by means of phosphorescent substances to the vicinity of the photocatalytically active surface (referred to below as photocatalyst PC), where the phosphorescent particles emit light of appropriate wavelength and activate the PC.

The phosphorescent particles (referred to below as microradiators MR) have to be “charged up” at an appropriate light source. They are then transported to the photocatalytically active layer, where they give out some or all of their stored electromagnetic energy before returning to the UV light source, and so on.

This has the advantage that, given selection of appropriate MR, the stored energy, with a half-life of a few seconds to minutes, is passed on to the PC within the reaction chamber, where the PC are able to exert their catalyst activity, whereas, owing to the short half-lives of the active state of the PC, they otherwise react only in the vicinity of the energy source.

Suitable reactors include various types of reactor which can be used for reactions and/or for mass transport operations, preferably the following:
fluidized bed, fluidized bed cascade, fluidized trough
spouted bed, cascade of spouted beds
loop reactor, cascade of loop reactors
stirred tank, stirred tank cascade
tube reactor
fixed bed (coated with PC) or any open, ordered structures such as platelets, honeycombs, etc.

With all of these processes the MR are activated at a light source, mixed physically with the reaction solution and the PC, returned to the light source after giving up their energy to the PC, “charged up”, and supplied again to the catalyst.

Mixing can take place in one instance by means of flows and particle diffusion within the apparatus. If these transport mechanisms are adequate, the light source—(a) UV lamp(s), for example—can be installed directly on the wall of the apparatus or within the apparatus, as a result of which the MR which flow past in the vicinity are charged up with high energy density before then returning, as a result of the flow, into the interior of the reactor.

These transport mechanisms can additionally be improved by means of baffles, impact plates, stirring mechanisms, etc.

Alternatively or additionally the MR can be guided past appropriate lamps by way of an external circuit. For this purpose it is preferred to separate the MR from the fluid to be treated and from the PC, in order to raise its concentration at the light source and to prevent shading by particles of PC and substrate. In this case the MR is preferably transported convectively with a small amount of the fluid to be treated.

The photocatalyst most frequently employed is TiO₂. With an energy band gap of 3.2 eV it can be activated with ultraviolet light having a wavelength of less than 385 nm. Also known, however, are many other photocatalysts, which can be activated with light having a wavelength higher than 385 nm. Examples that may be mentioned here include ZnO and the oxides of other transition elements (WO 95/11751) and also CdS (EP 0 234 875 B1) and SnO₂, SrTiO₃, WO₃, Fe₂O₃ (WO 96/36565). It would be possible to continue this series of examples further.

Recently, photocatalysts have been developed for the region of visible light (Leftmann, Christian: “Konventionelle und kombinatorische Entwicklung von Mischoxiden zur photokatalytischen Wasserreinigung mit sichtbarem Licht” [Conventional and combinatorial development of mixed oxides for the photocatalytic purification of water with visible light], dissertation at the University of the Saarland, 2001) and for the use of sunlight (EP 0 812 619 A1).

It is preferred to use relatively hard and abrasion-resistant PC, with preference being given to inorganic substances which are not oxidized. Depending on the way in which it is used the PC may vary greatly in particle size and structure.

| | | |
|---|---|---|
| Suspension catalysts: | Particle diameter: | 1 nm to 100 μm |
| Fluidized bed reactor: | Particle diameter: | 1 μm to 1 mm |

When using fixed beds (or any reactors with ordered structures such as platelets, honeycombs, etc.) the photocatalyst is fixed as a more or less thin layer on the stationary support.

The Microradiator MR

The microradiator MR is a phosphorescent solid which is used in particle form. It must have a sufficiently long afterglow time (amounting at least to seconds, better still several minutes or longer, preferably from 5 seconds to 30 minutes) and must emit in the wavelength range in which the photocatalyst can be activated.

Examples of Suitable Phosphorescent Solids

Many phosphorescent solids are known which emit in the visible range and which, although having been developed for other purposes, also cover all of the requirements of the application described herein. Rather than giving an extensive list, reference is made to the following literature, whose content is hereby incorporated:
U.S. Pat. No. 6,287,993, DE 195 21 119 A1, DE 199 26 980 A1, DE 199 34 436 A1

These MR are employed in combination, for example, with the photocatalysts (PC) described in Lettmann, Christian: “Konventionelle und kombinatorische Entwicklung von Mischoxiden zur photokatalytischen Wasserreinigung mit sichtbarem Licht” [Conventional and combinatorial development of mixed oxides for the photocatalytic purification of water with visible light], dissertation at the University of the Saarland, 2001).

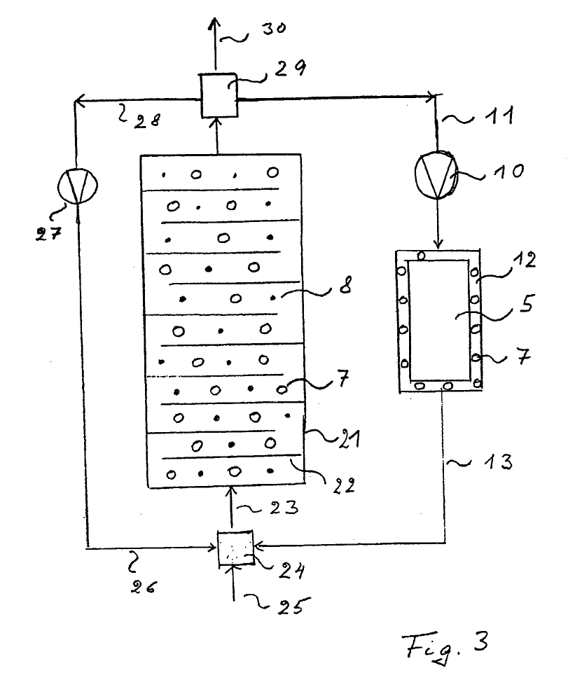

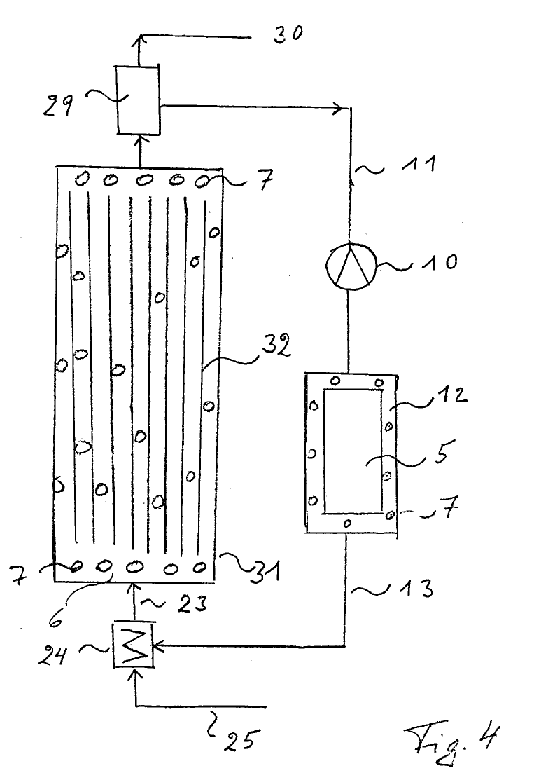

U.S. Pat. No. 6,287,993 describes substances with a long-lasting phosphorescence. They include, as described in Example 17, a glass which is doped with zinc and praseodymium and which, with an emission of 350 to 450 nm, is suitable for activating TiO₂ photocatalyst (cf. FIG. 3).

Additionally, DE 195 21 119 A1 describes “slowly subsiding” phosphorescent substances which can be utilized as TiO₂ activators since they also emit at below 400 nm. These are glasses which have been doped with rare earth metals.

In principle the particle size range of the MR, as for the photocatalyst PC, runs between 1 nm and 1 mm, preferably 1 μm-0.5 mm, depending on application. One efficient and economic solution, preferably for relatively large apparatus, is for the particle size of the MR to be well above that of the PC, so that one MR particle “charged up” at the lamp irradiates a very large number of PC particles. This has the advantage, furthermore, that the MR are easily separated from the fluid and the PC it contains by means of filters or sieves, and can be passed on for regeneration.

Another efficient and economic solution, preferably for small apparatus, is for the particle size of the MR to be well below that of the PC, in order to simplify the separation of MR from PC.

In principle, however, it is not possible to rule out any ratio between the particle sizes of PC and MR. This is so simply on the basis of the wide diversity of suitable apparatus types.

Suitable particles include solid particles, which are particularly easy to produce, but also particles where the phosphorescent material has been coated onto a support core. The use of a magnetic core opens up additional opportunities for the separation and transport of the MR particles.

Prevention of Abrasion on the MR and/or Corrosion and/or Dissolution of the MR

In order to prevent abrasion, the MR, if not already composed of glass, can be coated with a (thin) light-transmitting layer (e.g. glass). This layer may also protect against corrosion or dissolution of the MR in the fluid to be treated.

Separation of Photocatalyst PC and Microradiators MR

The separation of PC and MR (including abraded material) from the fluid can be accomplished by conventional methods such as filters, cyclones, centrifuges, etc. and also in the case of MR using magnetic separators (see above).

The separation of PC and MR from one another can be accomplished by way of the particle size (filters, cyclones) or else by the density (cyclones, centrifuges) or other physical differences (for example, magnetic core of the MR; see above).

One preferred process consists in separating relatively large MR from fluid and PC using a belt filter, activating the MR which have been separated off, using a high-energy light source, and returning them to the fluid from the end of the filter belt.

Particularly suitable light sources are UV lamps having the appropriate spectrum to excite the microradiator particles.

In the case of an external circuit, the lamp should be installed preferably in a special apparatus. The way in which this apparatus guides the MR particles ensures maximum efficiency of illumination of all the MR particles, by means, for example, of:
movement of the MR particles in a narrow gap around the lamp;
a flow with effective transport of particles transverse to the direction of the flow (e.g. in a fluidized bed with installed lamps or by imposing a turbulent flow, etc.).

The photocatalyst PC is preferably separated from the microradiator MR upstream of the external lamp, in order to prevent shading by the PC when the MR is being “charged up”.

Even in the case of direct irradiation within the apparatus, preference is given to (at least partial) separation of the PC from the MR in the vicinity of the lamp (by means, for example, of the flow regime or by means of upstream filters or magnetic fields when a magnetic core of the MR is being used).

It is self-evident that the reactor must be supplied not only with the fluid to be treated but also with the necessary reactants (e.g. supply of O₂ for the oxidation of organic impurities in water).

It is likewise generally necessary to separate off the reaction products (e.g. CO₂) from the treated fluid downstream of the reactor.

Suitability of the Solutions for Media and Reactions

The process of the invention is suitable for all chemical reactions which can be carried out on photocatalytically active surfaces in liquids or gases.

The invention finds preferred application for the oxidation of dissolved organic molecules, dispersed droplets and solid particles, microorganisms and viruses in water and gases (including gas bubbles in the case of water).

The wavelength of the light for “charging up” the MR and the wavelength emitted by the MR need not be same. In many cases the emitted light is shifted towards longer wavelengths. The light emitted by the MR should be of sufficiently high energy (short wavelength) for the necessary catalyst energy to be applied (e.g. UV light).

The term “light” can be substituted by the term “electromagnetic radiation of appropriate wavelength”; in other words, other wavelength ranges are also suitable provided that corresponding photocatalysts are used (especially visible light or sunlight).

The use of the microradiators MR achieves a packing density of the irradiated catalyst surface which is not possible with any of the known techniques. Moreover it is possible to use very simple apparatus, which may be already known. It need only be modified or adapted to the new process. Only the apparatus containing the external lamps may possibly need reconstructing.

### EXAMPLE 1

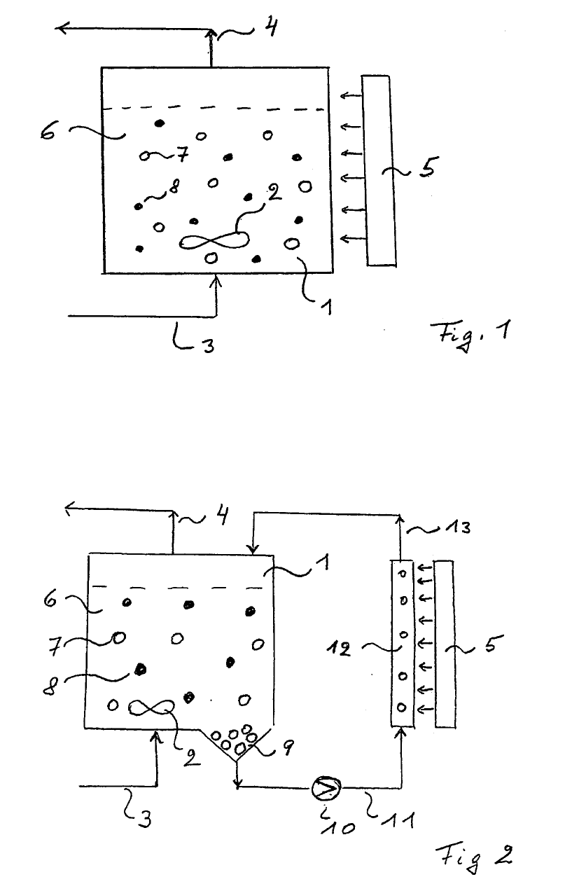

Laboratory Suspension Reactor According to FIG. 1

The reactor consists of the stirred vessel 1 with paddle stirrer 2, a feed line for oxygen (air) 3, an exhaust line for waste gases 4 and an external lamp (UV lamp) 5, and contains a suspension comprising a reaction medium 6, the microradiators 7 drawn as ∘, and the photocatalysts 8, drawn as ●.

The suspension, consisting of 500 ml of an aqueous solution of an organic substance and photocatalyst and also microradiator MR in a reactor volume of 800 ml, is stirred continuously to produce a circulating flow which descends at the centre and ascends at the walls, while a UV lamp (20 watts output at 350 nm radiation maximum) irradiates from the side (irradiated area: 50 cm²). Accordingly, averaged over time, all the MR particles arrive at the UV source, where they are activated. Air is passed through in the form of fine bubbles.

The addition of microradiator MR considerably increases the rate at which the organic component is broken down, by introducing radiation energy into the interior of the reactor.

### EXAMPLE 2

Laboratory Suspension Reactor with External Circulation of the Microradiator MR According to FIG. 2

The reactor consists of a stirred vessel 1 with paddle stirrer 2, a feed line for oxygen (air) 3, and an exhaust line for waste gases 4, there being provided below the stirrer 2 a sedimentation chamber 9 in which the relatively heavy MR 7 collect before being passed together with a small amount of fluid 6 via the pump 10 and line 11 into the external annular gap 12 of a UV lamp 5 and, following activation, fed via the line 13 from the top into the stirred tank 1.

The suspension—consisting of an aqueous solution of an oxidizable substance, photocatalyst, and microradiator—is stirred continuously and saturated with O₂ by passage of air through the suspension. The microradiator (0 to 10 g) is separated from the photocatalyst continuously in the sedimentation chamber and is guided back past a UV lamp to the laboratory reactor. The circulation rate is for example 5 or 10 ml/min. The external circuit contains, for example, 10 g of, in the case of two lamps, 20 g of additional MR to the amount in the stirred tank. The addition of microradiator substantially increases the rate at which the organic substance is broken down. Increasing the circulating volume flow also raises the rate of breakdown.

### EXAMPLE 3

Tube Reactor with Meander Ribs and Separate External Circulation of Photocatalyst (PC) and Microradiators (MR) According to FIG. 3

The reactor consists of a tube reactor 21 with installed horizontal ribs 22, arranged to form a meander, and is supplied from below, by the line 23 from the mixer 24, with a mixture consisting of reaction solution 6, which is enriched with oxygen and is supplied to the mixer via the line 25; photocatalyst 8, which is passed in circulation via the pump 27 and line 26/28; and microradiators 7, which are passed in circulation via the lines 11 and 13, the pump 10 and the annular jacket 12 surrounding the UV lamp 5. This mixture leaves the reactor via the separator 29, where it is separated into its components. The fully reacted reaction solution and also waste gases formed are taken off by way of the line 30.

### EXAMPLE 4

Tube Reactor with Photocatalyst-Coated Honeycomb Internals and External Activation According to FIG. 4

The reactor consists of the tubular reactor housing 1 with honeycomb internals 32 in the direction of the tube, which are coated with photocatalyst. Reaction solution 6 from the supply line 25 and activated microradiator 7 from the circulation line 13 are introduced into the reactor via the mixer 24 and line 23, pass through the honeycomb internals 32 and, in doing so, give up their photoenergy to the PC, before being separated from the solution 6 in the separator 29 and passed via line 11 and pump 10 into the annular jacket 12 of the lamp 5, where they are activated with UV light and passed back through the line 13 into the reactor.

1. Reactor for carrying out photocatalysed reactions in liquid or gaseous reaction media, comprising:
a reactor vessel with a solid photocatalyst;
feed lines and take-off lines;
mixing means;
a means of supplying electromagnetic radiation; and
microradiators suitable for absorbing the electromagnetic radiation and, with a time delay, for emitting light which excites the photocatalyst.

2. Reactor according to claim 1, wherein the means of supplying electromagnetic radiation is mounted on a radiation-transparent wall or in the interior of the reactor vessel and the mixing means is suitable for conveying the microradiators from the interior of the reactor vessel to the radiation source and back.

3. Reactor according to claim 1, wherein the means of supplying electromagnetic radiation is composed of a lamp and a fluid channel which communicates with the reactor vessel via transport lines and conveying means for the microradiators.

4. Reactor according to claim 3, wherein the lamp is of rod-shaped design and is surrounded by the fluid channel in the form of a jacket.

5. Reactor according to claim 3, wherein the reactor vessel is provided with means for separating the microradiators from the photocatalyst and/or from the reaction medium.

6. Reactor according to claim 1, suitable for the oxidation of organic impurities in water or wastewater, wherein feed lines are provided for air or oxygen and exhaust lines for the waste gases.

7. Reactor according to claim 1, wherein the reactor vessel is a fluidized bed reactor, a continuous-flow or tube reactor, a fixed bed reactor or a stirred tank reactor.

8. Reactor according to claim 1, wherein the photocatalyst has a particle diameter of from 1 nm to 100 μm in suspension reactors or from 1 μm to 1 mm in fluidized-bed reactors or fixed-bed reactors.

9. Reactor according to claim 1, wherein the microradiators have a phosphorescence half-life of from 5 seconds to 30 minutes and a particle size of from 1 nm to 1 mm.

10. (canceled)

11. Microradiators according to claim 21, wherein the support consists of magnetic material.

12. Microradiators according to 21, wherein the support is covered with a radiation-transparent layer.

13. (canceled)

14. Process according to claim 23, wherein after emitting their energy the phosphorescent particles are conveyed past the radiation source again and recharged.

15. Process according to claim 14, wherein the microradiators are separated from the photocatalyst and/or from the reaction medium before being passed to a separate radiation source and activated, before being then passed back into the reaction medium.

16. Process according to claim 23, wherein the photocatalytic reaction is an oxidation of organic compounds in aqueous solution.

17. Process according to claim 23, wherein the catalyst is TiO₂ particles and the microradiators are glass particles which have been doped with rare earth elements and can be excited with UV light or visible light.

18. Reactor according to claim 2, wherein the reactor vessel is provided with means for separating the phosphorescent particles from the photocatalyst and/or from the reaction medium.

19. Reactor according to claim 4, wherein the reactor vessel is provided with means for separating the microradiators from the photocatalyst and/or from the reaction medium.

20. Reactor according to claim 9, wherein the microradiators have a particle size of from 10 μm to 0.5 mm.

21. Microradiators for use in reactors for carrying out photocatalysed reactions in liquid or gaseous reaction media, said reactor comprising a reactor vessel with a solid photocatalyst, feed lines and take-off lines, mixing means, and a means of supplying electromagnetic radiation, wherein the microradiators are suitable for absorbing the supplied electromagnetic radiation and, with a time delay, for emitting light which excites the photocatalyst, said microradiators consisting of a phosphorescent material which has been applied to a support having a particle size of from 1 nm to 1 mm.

22. Microradiators according to claim 11, wherein the support is covered with a radiation transparent layer.

23. Process for carrying out photocatalytic reactions, comprising the steps of:
a) providing solid photocatalysts;
b) suspending the photocatalysts in a liquid or gaseous reaction medium or applying them to a surface;
c) providing microradiators which are charged up at an electromagnetic radiation source and which emit this energy with a time delay; and
d) activating the photocatalysts by means of the microradiators.
